(19) United States
(12) Patent Application Publication
(10) Pub. No.: US 2011/0078884 A1
(43) Pub. Date: Apr. 7, 2011

(54) TOOL FOR COMPRESSING AND INSERTING A PLIABLE MEMBER INTO A CHANNEL

(75) Inventor: Steven CONRAD, Tigard, OR (US)

(73) Assignee: SILTRONIC CORPORATION, Portland, OR (US)

(21) Appl. No.: 12/899,269

(22) Filed: Oct. 6, 2010

Related U.S. Application Data
(60) Provisional application No. 61/249,211, filed on Oct. 6, 2009.

(51) Int. Cl. B25B 27/28

(52) U.S. Cl. 29/235

(57) ABSTRACT

A tool is provided for compressing and inserting a pliable member past a rim of a channel and into the channel. The tool may be used to install o-rings in a segmented fashion. The tool may include a handle for the user to hold and operate the tool. A support for a press may be coupled to the handle. The support may be a shaft mounted partially within, and movable relative to, the handle. The shaft may include a slot adjacent the press to receive and be aligned with the pliable member. The handle and the press may be movable between a nominal position and a compressing position. The press may include pivoting arms with opposing faces, each having a beveled portion, that are operable, when moved to the compressing position, to compress the pliable member and push it into the channel. An actuator, such as a collar on the handle, may operate on the press arms as the handle is moved downwardly, to move them inwardly to the compressed position.

### TECHNICAL FIELD

The present invention relates to a tool for compressing and inserting a pliable member, such as an o-ring, into a channel and a method for using the tool.

### BACKGROUND

A pliable member, such as an o-ring, may be used as a seal between two surfaces by inserting the o-ring in a channel in one of the surfaces. Such an o-ring is used in semiconductor wafer reactors, such as the Gemini pancake reactors, where the bottom of the bell jar (encased in a stainless steel ring) provides one of the two sealing surfaces and a base plate provides the other. The base plate includes an open channel into which the o-ring is inserted. As the bell jar is raised and separates from the o-ring, the channel holds the o-ring in place. The channel does so by virtue of the o-ring having a cross-sectional diameter in an uncompressed state that is wider than the opening into the channel. This geometry requires that the o-ring be compressed for insertion into the channel.

Tools to aid in inserting o-rings into channels are known, particularly channels that are difficult to reach, e.g., a channel in an internal wall of a bore. Both U.S. Pat. No. 4,141,129 to Martini (1979) and U.S. Pat. No. 5,050,282 to Zannini (1991) show hand held tools for inserting o-rings into channels within a bore. Both of these disclose tools that carry the entire o-ring prior to and during insertion, and thus can be used only for small circumference o-rings (on the order of a few centimeters). Martini does not disclose any capability for facilitating insertion into a channel narrower in cross-section than the o-ring's cross-section. Zannini uses a contact finger that is rotated around, and pushed along, a flared portion of a shaft to push the o-ring into the channel within an interior cavity. Zannini does not disclose inserting the o-ring into a channel narrower than the o-ring.

Grabler et al, U.S. Pat. No. 4,571,804 (1986) uses opposing arms to hold the o-ring and to maneuver the o-ring into the channel in the internal bore, which channel is wider in cross-section than the o-ring. Thus the prior art provides no tool with a utility for the case where a channel has a width, at an upper opening or at another point, past which the o-ring is to be inserted, that is less than an outer width of the o-ring, such that a compression in cross-section of the o-ring is required for insertion.

Hand insertion of o-rings in such channels, particularly where the o-rings are greater than 0.25-inches in cross-sectional diameter, is difficult and time-consuming. Such insertion tends to cause physical soreness and discomfort because a large amount of point load force is needed to insert small segments of the o-ring, and this must be repeated until the complete circumference of the o-ring is inserted. Pancake reactor o-rings typically have a circumferential length on the order of several feet. However, no tool is known to provide adequate assistance for such insertion.

### SUMMARY

The present disclosure is directed toward a tool for compressing and inserting a pliable member past an opening that is narrower than the pliable member, and methods for producing and using such a tool. For example, the pliable member may be an o-ring with a greater cross-sectional diameter than the width of a rim of a channel into which the o-ring is to be inserted. The tool may include a support providing a slot for the pliable member that aligns the tool with the pliable member adjacent the rim of the channel. A press may be mounted adjacent the slot to compress the pliable member and to push the pliable member out of the slot and past the rim. An actuator may be coupled to the press for a user to control the movement of the press from a nominal position to the compressing position.

The tool may include a handle for the user to hold and operate the tool. The support may include a shaft that is movably mounted partially within, and partially extending out of the handle. The press may include a pair of arms pivotally coupled at a lower end of the shaft, each arm including a face opposing the other arm's face and having a beveled portion on the face to compress and push downwardly on the o-ring. The tool may be operated by pressing the handle downwardly relative to the shaft.

The actuator may include a collar, adjustably coupled to the lower end of the handle, operable on the press arms to pivot them inwardly to the compressed position. A stop and a spring may be provided in the handle and operable respectively to arrest the downward motion of the actuator and to return the handle to the nominal position.

The press arms may be L-shaped with the faces and beveled portions at the tips of the bases of the L-shapes. The shaft may include a pair of opposed grooves to receive the press arms as they move into the compressed position. The shaft may include a pair of notches alongside the slot for the pliable member, allowing the faces of the press arm to contact the o-ring in the slot, and to compress and push it into the channel.

The shaft may include a ring cooperating with a ridge in the handle to provide a limit on upward movement of the handle relative to the shaft.

### BRIEF DESCRIPTION OF THE DRAWINGS

FIG. 1 is a side view of an embodiment of the present invention, showing the tool with a handle, an adjustment collar coupled to the handle, a shaft extending out of the handle, and a press disposed on the shaft.

FIG. 2 is an exploded view of the components of the tool of FIG. 1 showing the handle, a plug and stop to be installed in the handle, a spring disposed between the plug and the shaft, the press to be coupled to the shaft, and showing in dashed lines an internal cavity in the handle to receive the plug, stop, shaft, and adjustment collar, and a hole within the shaft to receive the stop.

FIG. 3 is a cross-sectional view of the tool of FIG. 1 showing, in a nominal position, the handle, the plug, the spring, the shaft, the adjustment collar, and the press, and showing in dashed lines the adjustment collar in the compressing position when the handle is moved downwardly relative to the shaft.

FIG. 4 is an enlarged view of the lower end of the tool of FIG. 1 showing arms that provide the press in a nominal position (solid line) and compressing position (dashed line) and operating on a pliable member in a slot at the end of the shaft and positioned at a rim of a channel.

FIG. 5 is a view from below of the tool of FIG. 5 showing the slot for the pliable member and the lower portions of the press arms in the compressing position.

FIGS. 6a-b show a preferred embodiment of the handle of the tool of the present invention.

FIGS. 7a-b show a preferred embodiment of an outer collar to provide a handle stop on the handle of the tool of the present invention.

FIGS. 8a-b show a preferred embodiment of a cap for the handle of the tool of the present invention.

FIGS. 9a-b show a preferred embodiment of a rod to be coupled to the cap within the handle of the tool of the present invention.

FIGS. 10a-c show a preferred embodiment of a shaft to be installed within the handle of the tool of the present invention.

FIGS. 11a-b show a preferred embodiment of a ring to be coupled to the shaft of the tool of the present invention.

FIGS. 12a-b show a preferred embodiment of an adjustable collar to be coupled to the handle of the tool of the present invention.

FIGS. 13a-b show a preferred embodiment of one of the arms that provide the press of the tool of the present invention.

### DETAILED DESCRIPTION

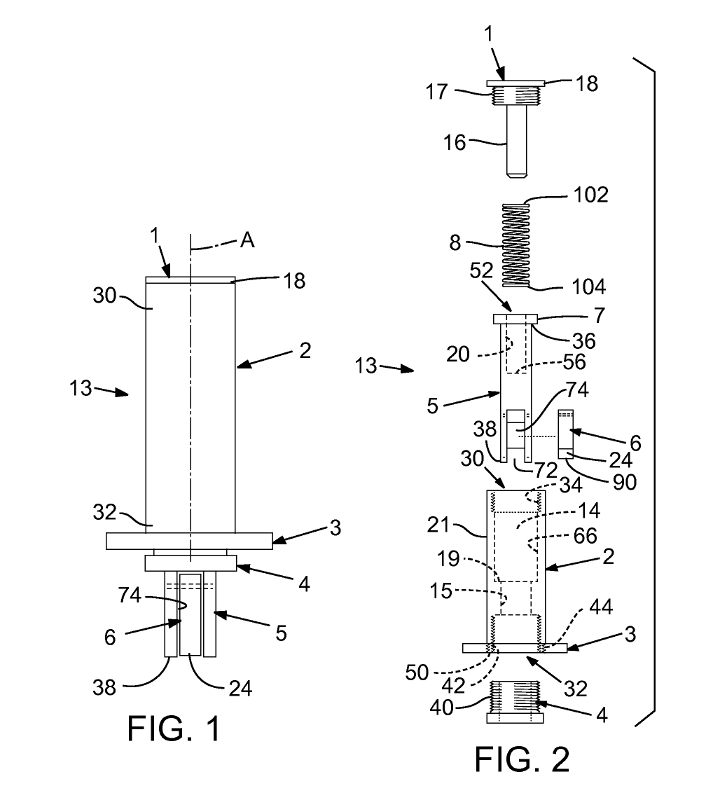

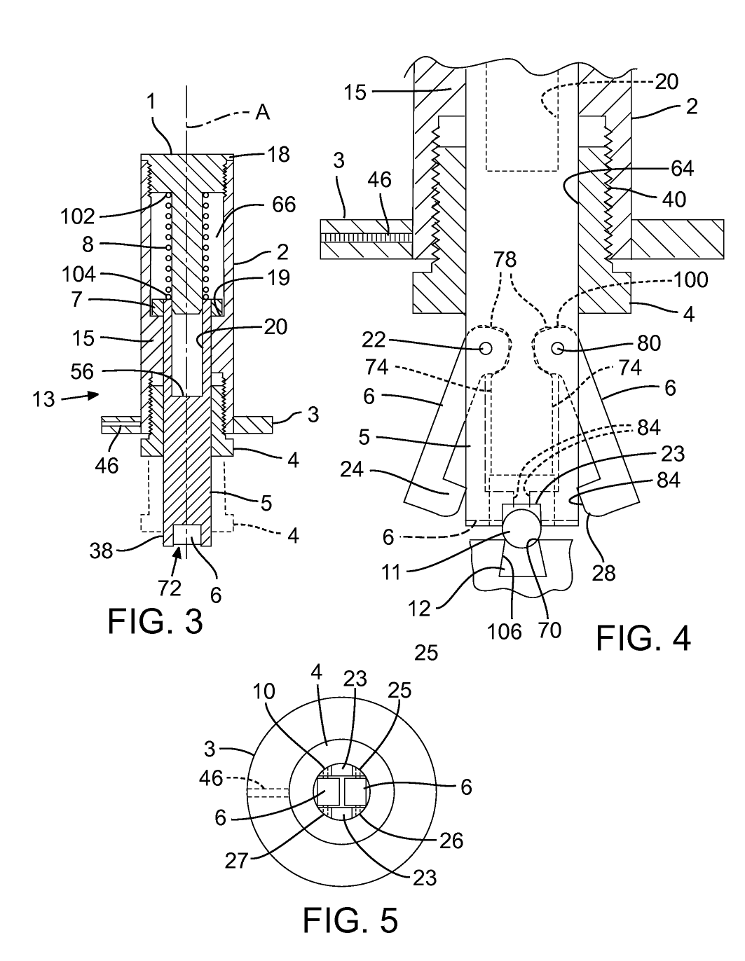

FIGS. 1-5 show a tool 13 according to an embodiment of the present invention. Tool 13 may include a handle 2, typically an elongate, cylindrical handle sized and shaped for grasping and operation of the tool by one hand of a user. Handle 2 is typically manufactured of suitable, rigid material and with an internal cavity 14 in communication with an upper open end 30 and lower open end 32. Upper end 30 may be closed off, such as by a plug 1 with external threads 17 screwed into internal threads 34 formed inside of handle 2, or other suitable construction.

A support, such as shaft 5, for a press, such as two opposed arms 6, may be movably coupled to handle 2, and may be partially within handle cavity 14, and partially extending out of lower end 32 of handle 2. Handle 2 and shaft 5 typically define a longitudinal axis A.

Shaft 5 defines an upper or proximal end 36 and a lower or distal end 38. Upper end 36 may include a stop, such as ring 7, cooperating with a ridge 19 in handle cavity 14 to establish a limit on a lower position of shaft 5 relative to handle 2. Press 6 is typically coupled to support 5 adjacent lower end 38. An adjustment collar 4 may be coupled to handle 2 at lower end 32, e.g., by external threads 40 on collar 4 engaging with internal threads 42 within handle 2. A hand stop or base, such as collar 3 may be disposed on handle 2 adjacent lower end 32, typically providing a sufficiently wide flange such that the heel of the user's hand can press against it to aid in pushing handle 2 down in operation of the tool.

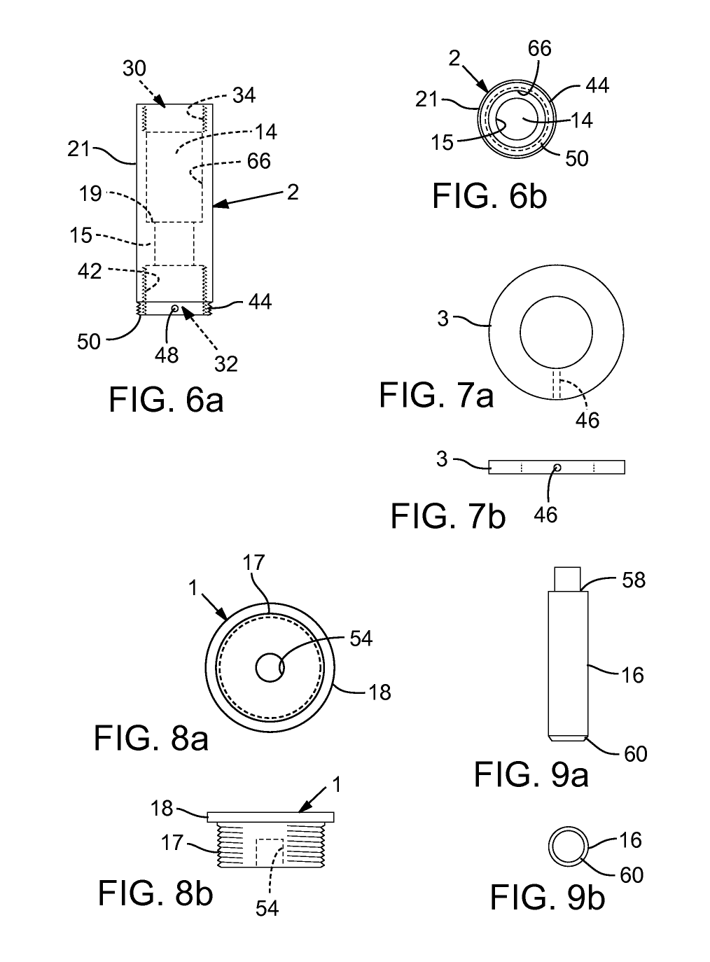

The invention will be described with respect to a preferred embodiment herein with the understanding that suitable materials may be used in place of those described for the preferred embodiment and dimensions may be varied within the scope of the invention. In a preferred embodiment, as shown in FIGS. 6a-b, handle 2 may be made of a stainless steel tube, 4.4-inches in length, 1.5-inches in outer diameter, with a 0.35-inch wall. Upper end 30 may be tapped for 1.25-12 UNF thread 34 to about 0.5-inches deep. Plug 1 (FIGS. 8a-b) may be a stainless steel plug with a lid 18 and a threaded portion 17 configured to engage threads 32 over a depth of at least about ⅜-inches. Plug 1 may include, on a lower face opposite lid 18, a centered hole 54 with, e.g., a 0.31-inch diameter and a 0.31-inch depth for purposes to be described below.

Within handle 2, below thread 34, internal cavity 14 may include a bored section 66, with a diameter of 1.1718-inches to 1.1735-inches for a class 2 sliding fit with ring 7 on shaft 5. An example of such a fit is defined by the American National Standards Institute standards for running and sliding fits (ANSI B4.1-1967, R1994) e.g., an RC2-n fit, where RC refers to running or sliding fits in general, and “n” is a number denoting the level of tolerance. Bored section 66 may be provided with a 2.466-inch overall depth from thread 34 to ridge 19.

Handle cavity 14 may include, typically below bored section 66, a narrowed section 15 that may extend from ridge 19 down to threaded portion 42. Narrowed section 15 is preferably bored for a class 2 sliding fit with the portion of shaft 5 that is below ring 7. For example, section 15 may have a 0.812-inches to 0.817-inches inner diameter.

An outer wall 21 of handle 2 at lower end 32 may be tapped for 1.5-18 UNC thread 44 with a 0.28-inch depth for connection of the hand stop collar 3. Collar 3 (FIGS. 7a-b) may be a disc 2.75-inches in outer diameter with a thickness of 0.25-inches. A hole 46 (see FIGS. 6-7) may be drilled radially through collar 3 and a 0.125-inch stainless steel roll pin (not shown) may be pressed through hole 46 in collar 3 and into a corresponding hole 48 in handle 2. Hole 48 may be centered 0.125-inches from lower edge 50 of handle 2, providing a flush fit of collar 3 with lower edge 50.

Handle 2 may be tapped inside of lower end 32 with 1.25-12 UNF thread 42 for a depth of 0.875-inches. Adjustment collar 4 may be adjusted in position along longitudinal axis A by screwing collar thread 40 into and out of handle thread 42. Preferably, adjustment collar 4 (FIGS. 12a-b) is made of a rigid body, high strength composite material, such as PEEK, and thread 40 has a depth of 0.875-inches. The overall length of collar 4 is preferably 1.125-inches with an outer collar ring 62 of diameter 1.5-inches. Collar 4 preferably is bored with a through hole 64 for sliding fit with shaft 5.

Typically, shaft 5 is movable within handle cavity 14, along longitudinal axis A, for a distance generally limited by the depth of bored section 66 and the relative sizes and positions of ring 7 and plug 1 and/or by a stop to be described below. Shaft 5 may also include a hole 20 defined by an opening 52 adjacent upper end 36 of shaft 5 and a barrier, such as a bottom 56 of hole 20.

Plug 1 may be coupled to a stop, such as an elongate member or rod 16 defining an upper end 58 and a lower end 60. Rod 16 may be attached adjacent upper end 58 to plug 1 of handle 2. Lower end 60 typically extends downward within handle cavity 14 and through opening 52 into shaft hole 20. Stop 16 is movable within hole 20 downwardly from a nominal position. Stop 16 cooperates with barrier 56 within the shaft to arrest the downward movement of handle 2 and adjustment collar 4 at a stopped position. E.g., when handle 2 and collar 4 are moved down on shaft 5 to the compressed position, lower end 60 of rod 16 contacts barrier 56 in hole 20, preventing further downward motion of handle 2 and collar 4. Typically stop 16 is sized, and collar 4 is adjusted, to prevent collar 4 from moving to or beyond lower end 38 of shaft 5, thus preventing collar 4 from striking, for example, a base plate that has the channel into which the pliable member is being installed.

Rod 16 preferably (FIGS. 9a-b) is a solid tube of a low friction composite material, such as a UHMW material, and—2.248-inches in length and 0.475-inches to 0.500-inches in diameter for a sliding fit within shaft hole 20. Upper end 58 preferably has a diameter reduced to 0.31-inches over a 0.31-inch depth for press fit into hole 54 of plug 1. Lower end 60 of rod 16 preferably is flat with a beveled edge with a radius of 0.0625-inches.

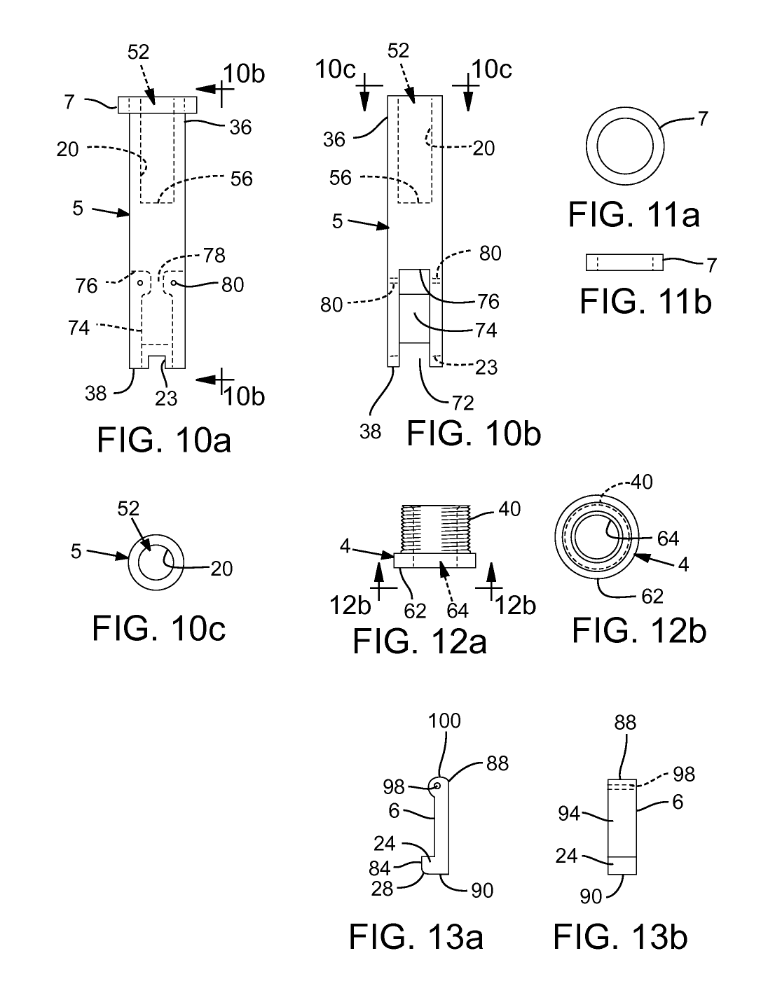

Shaft 5 is preferably (FIGS. 10a-c) a stainless steel rod of 3.97-inches length, with an outer diameter machined for sliding fit into handle 2, particularly in narrowed section 15, e.g., 0.809-inches to 0.81-inches. Hole 20 in shaft 5 is bored preferably to a 1.563-inches depth with an inner diameter for a class 2 sliding fit with rod 16 of 0.500-inches to 0.504-inches. Ring 7 is preferably made of a rigid body, high strength composite material, such as PEEK, with an outer diameter machined for a sliding fit in handle 2, particularly within bored section 66, e.g., 1.1686-inches to 1.1703-inches. Ring 7 preferably (FIGS. 11a-b) is 0.25-inches thick with an inner diameter sized for a press fit, or otherwise permanently attached, onto upper end 36 of shaft 5, flush with the top of shaft 5.

Shaft 5 may be structured adjacent lower end 38 to receive a pliable member 11 (FIG. 4) and to orient the tool with respect to the pliable member, and to support the press for operation on pliable member 11. Lower end 38 of shaft 5 typically includes a slot 23 sized and shaped to receive the pliable member and orient the tool with respect to the pliable member adjacent a rim 70 of channel 12. Slot 23 typically has a width that is about 2-mm to 3-mm smaller than the diameter of the intended o-ring and a depth of about ⅔ of the o-ring diameter. Slot 23 preferably is centered on longitudinal axis A and machined to be 0.274-inches wide and 0.15-inches deep. This size is preferable for use with an o-ring with a circular cross-section and a diameter of about 0.25-inches. Other slot sizes may be appropriately chosen for other sizes and shapes of o-rings and other pliable members.

Arms 6 are typically mounted on shaft 5 adjacent slot 23 and provided with access to slot 23 for compressing pliable member 11. E.g., a pair of notches 72 may be provided at lower end 38 of shaft 5 alongside slot 23. Notches 72 typically extend perpendicular to, and provide openings into, slot 23 and are centered on longitudinal axis A. Preferably notches 72 are machined to be 0.43-inches wide and 0.344-inches deep. In a typical configuration, creation of slot 23 and notches 72 in lower end 38 of shaft 5 leaves four posts 10, 25, 26, and 27 to support the tool above the intended o-ring.

Above notches 72, a pair of opposed grooves 74 may be provided to receive arms 6, preferably with a clearance fit. Grooves 74 typically extend along shaft 5, preferably substantially parallel to longitudinal axis A. Grooves 74 are preferably machined to be 0.438-inches wide, 1.406-inches in overall length, and about 0.187-inches deep. An upper end end 76 of each groove 74 may be provided with a well 78 and throughholes 80 for locating a hinge 22 for arms 6.

As noted above, press 6 is preferably a pair of arms, each of which includes a face 84 disposed to contact pliable member 11 when it is in slot 23. Faces 84 typically oppose one another and are operable in a compressing position of the press (dashed lines in FIG. 4) to compress a middle portion 86 of pliable member 11 therebetween to a compressed width that is less than a width of rim 70 of channel 12.

Arms 6 each define a proximal end 88 and a distal end 90. Arms 6 may be coupled adjacent proximal end 88 at a hinge 22 or other pivotal connection shaft 5, preferably in groove 74. Opposing faces 84 of arms 6 may be provided adjacent distal end 90 of arm 6. For example, arm 6 may include an upper portion 94 extending substantially parallel to longitudinal axis A of shaft 5 and a lower portion 24 extending at substantially a right angle to upper portion 94, defining an L-shape with each lower portion 24 extending inwardly toward longitudinal axis A of shaft 5. In such configuration face 84 is provided at the distal end of lower portion 24, i.e., at the tip of the base of the L-shape.

With hinged connection 22, arms 6 are pivotal between a nominal position (solid lines in FIG. 4) of the press and the compressing position (dashed lines) of the press. One or both of faces 84 may include a beveled portion 28 configured to push pliable member 11 downwardly out of slot 23 and past rim 70. Typically beveled portion 28 is on a lower portion of face 84. Preferably, pliable member 11 is substantially contacted only by beveled portion 28 of face 84 as the press is moved from the nominal position to the compressing position.

Compression arms 6 preferably (FIGS. 13a-b) are made of a stainless steel construction, with a length from a hinge hole 98 (preferably of diameter 0.062-inches) to the distal end of upper portion 94 of 1.216-inches and a width of 0.375-inches to fit with clearance in grooves 74. Upper portion 94 preferably has a thickness of 0.187-inches. Upper portion 94, around hinge hole 98 may be provided with a circular outer shape 100 for pivoting in well 78, preferably with an outer radius of 0.15-inches.

Lower portion 24, which alternatively may be characterized as a protruding flange or a tab, preferably extends 0.187-inches from upper portion 94 to face 84. Lower portion 24 may be provided with a depth of 0.25-inches. Notches 74 are typically deeper than the depth of lower portion 24, so notches 74 preferably are provided with a depth of 0.344-inches. Thus, notches 72 provide access for faces 84 of press arms 6 to pliable member 11 in slot 23. Beveled portion 28 is shaped for sliding contact over o-ring 11, preferably a quarter-circle shape with a radius of 0.1-inches.

For tool assembly, shaft 5 may be assembled with ring 7 and arms 6 and inserted through opening 30 in the top of handle 2, prior to installation of plug 1. Shaft 5 may be inserted into handle cavity 14 until ring 7 and ridge 19 meet. Then, plug 1, with rod 16 press fitted thereto at hole 54, and with spring 8 disposed on rod 16, may be installed in handle 2. Spring 8 is a biasing member with an upper end 102 biased against the upper end of handle 2 at plug 1 and a lower end 104 biased against ring 7. Spring 8 thus holds handle 2 in a suspended position above shaft 5. Typically in such suspended position, which ordinarily corresponds with the nominal position of the press, a small length of rod 16 extends into shaft hole 20.

In use, the tool handle 2 is configured to be gripped, and the tool operated, by a single hand of a user to compress a portion of pliable member 11 and insert it past rim 70 and into channel 12 through the actuation of vertically pivoting compression arms 6. An actuator is provided by adjustment collar 4 mounted to handle 2, and the actuator is selectively operable, by the user's plunging the handle downwardly, to move press 6 from the nominal position to the compressing position. Spring 8 is operatively coupled to the actuator and urges the actuator to a non-actuated position wherein the press is in the nominal position. The press, when moved to the compressing position with pliable member 11 in slot 23, compresses pliable member 11 and pushes it out of slot 23 and past rim 70. Rod 16 and barrier 56 typically provide a stop, operatively coupled to the actuator, that allows the actuator to move the press to the compressed position but then prevents further downward movement of the actuator.

Collar 4 may be adjustable in position relative to lower end 32 of handle 2, for example by being coupled by a threaded engagement. Adjusting the position of collar 4 alters a relationship between the actuator and the press. Typically, moving collar 4 lower with respect to handle 2 provides more compression, for the same downward plunging of handle 2 by the user, while moving collar 4 higher, by screwing it farther into handle 2 provides less compression, for the same downward plunging of handle 2 by the user.

Typically pliable member 11, in a non-compressed state, defines in cross-section an at least partially curved shape with a lower portion defining a width less than the width of the channel rim. Pliable member 11 further typically includes a middle portion above the lower portion that defines a width greater than the width of the channel rim. For example, pliable member 11 may be an o-ring or other tube, solid or hollow, which has a nominally circular cross-section. Such o-ring, placed on top of its target channel, includes a small cross-section that falls into the channel and also includes the middle portion, i.e., the midline of the circular cross-section, that is wider than the channel rim.

Channel 12, for use with an o-ring, will typically be elongate and define in plan view a substantially circular shape. Such channels may hold the o-ring in place within a wider portion 106 of the channel below the channel rim 70. For example, the channel walls may be angled such that a cross-sectional view depicts a trapezoid with angled left and right sides and the longer parallel side at the bottom of the channel and the shorter parallel side across the rim of the channel. This channel construction allows the o-ring to remain firmly intact as the bell jar is raised during processing.

The embodiments of the invention described herein thus provide a tool that operates by a plunging motion that assists with vertically seating the o-ring into the channel. This seating occurs in a point focused manner without stretching of the o-ring. Preferably, the stainless steel handle or other construction provides a weight that assists with the required plunging force, balanced with the internal spring tension to assist with the handle's retraction in preparation for the next compression. The physical package for such a tool is typically compact for easy maneuvering around the entire circumference of the o-ring channel.

In operation, the tool is positioned with posts 10, 25, 26, and 27 over the o-ring such that the upper portion of the o-ring is received inside slot 23. Posts 10, 25, 26, and 27 may rest on the surface of the base plate adjacent the o-ring channel. At this point, compression arms 6 are pushed slightly outward in a butterfly motion, being so moved by the o-ring's insertion into slot 23. The user's gripping handle 2 with one hand and pushing in a downward plunging motion, causes adjustable collar 4 to move along shaft 5 and over arms 6, thus pivoting arms 6 inwardly to an increasing degree the further collar 4 is moved.

Compression arm tabs 24, at beveled portions 28, are typically in a position such that they contact the o-ring at a vertical point slightly above the horizontally thickest portion of the o-ring. Thus, tabs 24 simultaneously compress the o-ring diameter horizontally to reduce cross-sectional width as they apply downward force to the o-ring. This action, which is powered by the upper body and arm of the user, readily provides sufficient force for o-ring insertion, particularly as compared to the force necessary to be applied by the user's fingers in the absence of the tool. As the user withdraws the force that enabled plunging action of handle 2, spring 8 returns handle 2 to the suspended, nominal starting position.

O-ring 11 is compressed by tabs 24 of arms 6, which move through notches 72 and into slot 23, occupying the space in the tool where the o-ring had been located. Since typically the depth of slot 23 is less than the diameter of the o-ring, and tabs 24 in the compressed position are seated on the reactor's base plate and roughly flush with lower end 38 of shaft 5, tabs 24 move over the top of the o-ring. Thus, the o-ring, including its widest portion, is moved firmly down to the appropriate depth within the channel.

Slot 23 may be similar in width to the o-ring channel rim on the target surface—a typical example noted above is for slot 23 to be 2-mm to 3-mm smaller. Slot 23 typically guides the tool's placement and also immobilizes a small section of the o-ring, particularly against lateral movement. As the handle is plunged downward, the opposing arms are preferably compressed over the top half of the target o-ring. The beveled edges of the arms squeeze and decrease the horizontal diameter of the o-ring, while simultaneously pushing it downward into the channel

The tool typically plunges a specific distance as controlled by the length of rod 16 in cooperation with barrier 56. For adjustment of the distance for various o-rings and channels, collar 4 can be screwed in or out by the user to control the amount of compression transferred to the compression arms, and/or rod 16 may be adjusted in length or different lengths used for different versions of the tool.

Additionally, although the tool for compressing and inserting a pliable member into a channel has been shown and described with reference to the foregoing operational principles and preferred embodiments, those skilled in the art will find apparent that various changes in form and detail may be made without departing from the spirit and scope of such claims as may be placed in a non-provisional application claiming priority to the present application. The present disclosure is intended to embrace all such alternatives, modifications, and variances that fall within the scope of such claims.

The invention claimed is:

1. A tool for compressing and inserting a pliable member past a rim of a channel and into the channel, the tool comprising:
a support providing a slot, wherein the slot is configured to receive the pliable member and to align the tool with the pliable member adjacent the rim of the channel;
a press mounted adjacent the slot and movable between a nominal position and a compressing position, wherein the press in the nominal position applies substantially no compression to the pliable member, and wherein the press is operable, when moved to the compressing position with the pliable member in the slot, to compress at least a portion of the pliable member in the slot and to push the pliable member out of the slot and past the rim;
an actuator coupled to the press, the actuator selectively operable to control the movement of the press from the nominal position to the compressing position.

2. The tool of claim 1 further comprising a handle coupled to the actuator, the handle configured to be held by a user for positioning the tool on the pliable member adjacent the channel, and wherein the handle controls the actuator to move the press from the nominal position to the compressing position.

3. The tool of claim 2 wherein the handle is biased to place the press in the nominal position.

4. The tool of claim 2 wherein the handle is configured to be gripped for operation of the tool by a single hand of a user.

5. The tool of claim 2 wherein the support includes a substantially cylindrical shaft having a proximal end and a distal end, wherein the slot and the press are disposed adjacent the distal end of the shaft and wherein the handle is disposed adjacent the proximal end of the shaft.

6. The tool of claim 1 wherein the press is a pair of arms, each arm including a face disposed to contact the pliable member when the member is in the slot, wherein the faces oppose one another and are operable in the compressing position of the press to compress the middle portion of the pliable member therebetween and to push the pliable member downward, such that the pliable member moves past the channel rim.

7. The tool of claim 6 wherein the press arms each define a proximal end and a distal end, and wherein the proximal end of each press arm is pivotally coupled to the tool.

8. The tool of claim 7 wherein the opposing faces of the arms are each adjacent the distal end of the arm.

9. The tool of claim 8 wherein the press arms are pivotal between the nominal position of the press and the compressing position of the press.

10. The tool of claim 9 wherein the faces include a beveled portion configured, when the arms are pivoted from the nominal position to the compressing position, to push the pliable member out of the slot and past the rim.

11. The tool of claim 6 wherein the support includes a shaft having a proximal end and a distal end, wherein the slot and the press are disposed adjacent the distal end of the shaft, the tool further including a handle disposed adjacent the proximal end of the shaft, the handle defining an upper end, an open lower end, and a cavity therebetween, and wherein the shaft is disposed partially within the handle cavity and partially extends out of the lower end, and further wherein the handle is movable relative to the shaft.

12. The tool of claim 11 wherein the actuator includes a collar coupled to the handle adjacent the lower end of the handle, wherein the collar is adjustable in position relative to the lower end of the handle and wherein adjusting the position of the collar alters a relationship between the actuator and the press.

13. The tool of claim 11 wherein the shaft defines a longitudinal axis and the shaft includes a pair of opposed grooves adjacent the distal end of the shaft, each groove extending substantially parallel to the longitudinal axis of the shaft and each configured to receive one of the press arms therein.

14. The tool of claim 11 wherein the shaft includes a pair of notches alongside the slot for the pliable member, the notches providing access for the faces of the press arm to the pliable member in the slot.

15. The tool of claim 11 wherein the handle cavity includes a ridge therein, and further wherein a ring is coupled adjacent the proximal end of the shaft, the ring cooperating with the ridge in the handle cavity to limit the movement of the handle relative to the shaft.

16. The tool of claim 11 further including a rod disposed within the handle cavity that cooperates with a barrier on the shaft to arrest the movement of the actuator, the rod defining an upper end and a lower end, the upper end attached to the handle adjacent the handle upper end, and further wherein the shaft includes a hole extending from an opening adjacent the proximal end of the shaft down to the barrier, the opening configured to receive the lower end of the rod therein and the rod movable within the hole from a nominal position to a stopped position, wherein the lower end of the rod, in the stopped position, is in contact with the barrier.

17. The tool of claim 11 further including a biasing member coupled to the actuator, the biasing member urging the actuator to a non-actuated position wherein the press is in the nominal position, and wherein the biasing member is a spring defining an upper end biased against the upper end of the handle and a lower end biased against the shaft.

18. The tool of claim 1 further including a biasing member coupled to the actuator, the biasing member urging the actuator to a non-actuated position wherein the press is in the nominal position.

19. A tool for receiving, compressing, and ejecting a pliable member, the tool comprising:
a support that includes a shaft having a proximal end and a distal end, the shaft having adjacent the distal end a slot configured to receive the pliable member;
a pair of pivotally mounted press arms adjacent the slot, each arm including a face disposed to contact the pliable member when the member is in the slot, the press arms movable between a nominal position and a compressing position, wherein the press arms in the nominal position apply substantially no compression to the pliable member, and wherein the press arms are operable, when moved to the compressing position with the pliable member in the slot, to compress at least a portion of the pliable member between the press arm faces and to eject the pliable member from the slot;
an actuator coupled to the press arms, the actuator selectively operable to control the movement of the press arms from the nominal position to the compressing position; and
a handle coupled to the actuator, the handle configured to be held by a user for positioning the tool on the pliable member, and wherein the handle controls the actuator to move the press from the nominal position to the compressing position.

20. A handheld tool operable by a user to receive, compress, and eject a pliable member, the tool comprising:
a support that includes a shaft having a proximal end and a distal end, the shaft having adjacent the distal end a slot configured to receive the pliable member;
a handle disposed adjacent the proximal end of the shaft, the handle defining an upper end, an open lower end, and a cavity therebetween, and wherein the shaft is disposed partially within the handle cavity and partially extends out of the lower end, and further wherein the handle is movable relative to the shaft;
a press mounted adjacent the slot and movable between a nominal position and a compressing position, wherein the press in the nominal position applies substantially no compression to the pliable member, and wherein the press is operable, when moved to the compressing position with the pliable member in the slot, to compress at least a portion of the pliable member and to eject the pliable member from the slot;
an actuator coupled to the press arms, the actuator selectively operable to control the movement of the press arms from the nominal position to the compressing position, and wherein the handle is configured to be held by the user and to control the actuator to move the press from the nominal position to the compressing position, and wherein the actuator includes a collar coupled to the handle adjacent the lower end of the handle, wherein the collar is adjustable in position relative to the lower end of the handle and wherein adjusting the position of the collar alters a relationship between the actuator and the press.
